(19) United States
(12) Patent Application Publication
(10) Pub. No.: US 2009/0174539 A1
(43) Pub. Date: Jul. 9, 2009

(54) UEI FUEL & DRIVING MONITOR

(76) Inventor: Paul Benyola, Cherry Hill, NJ (US)

Correspondence Address: Universal Energy Innovations LLC, 11 Sayer Ave., Cherry Hill, NJ, 08002, US

(21) Appl. No.: 12/167,568

(22) Filed: Jul. 3, 2008

Related U.S. Application Data
(60) Provisional application No. 61/019,496, filed on Jan. 7, 2008.

(51) Int. Cl. B60Q 11/00

(52) U.S. Cl. 340/439; 340/450.2

(57) ABSTRACT

This invention, UEI FUEL & DRIVING MONITOR, will monitor and record on a SD/Flash memory card, the events that exceed the proprietary software/hardware preprogrammed for acceleration, braking, left and right turns, or swerving. The events will be recorded and retrieved by a PC program for analysis of driving habits. The LED lights will give the driver immediate visual and audio output of their driving and fuel consumption by displaying RED=POOR, YELLOW=FAIR, GREEN=GOOD, by modifying their driving habits to drive mostly in the GREEN=GOOD area they will be able to conserve fuel, be a safer driver and also reduce wear on the vehicle. This is new technology using proprietary hardware and software developed by Universal Energy Innovations, LLC.

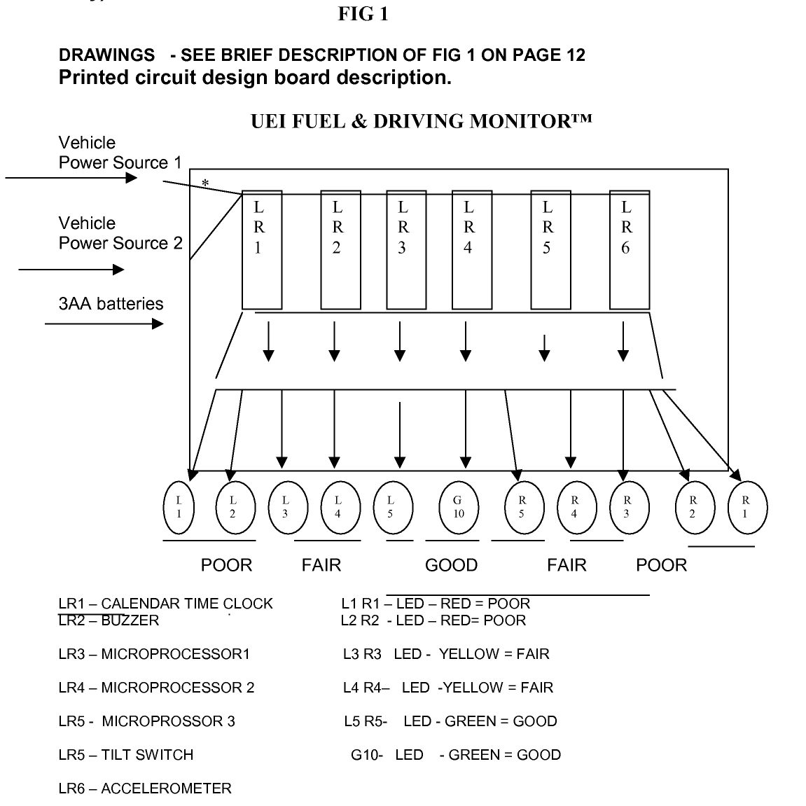

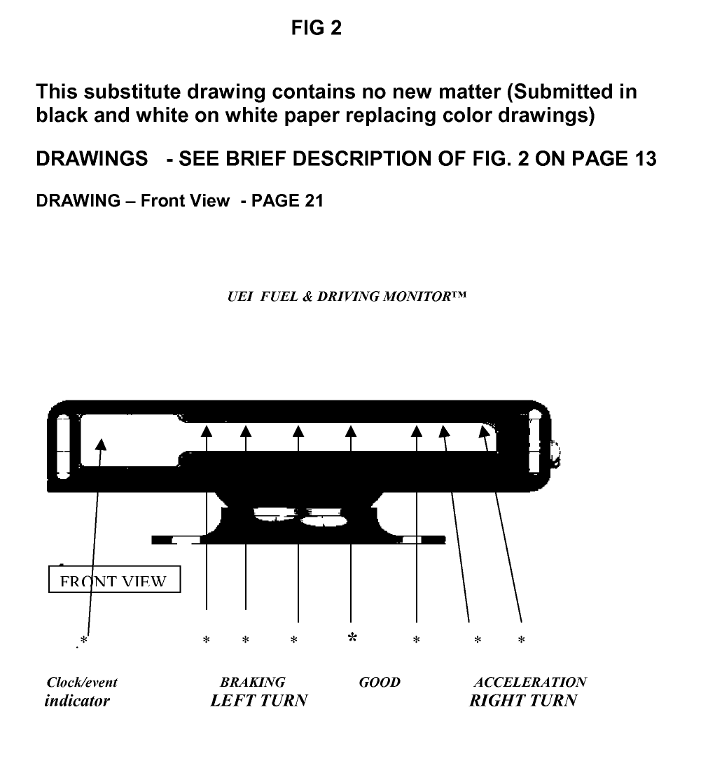

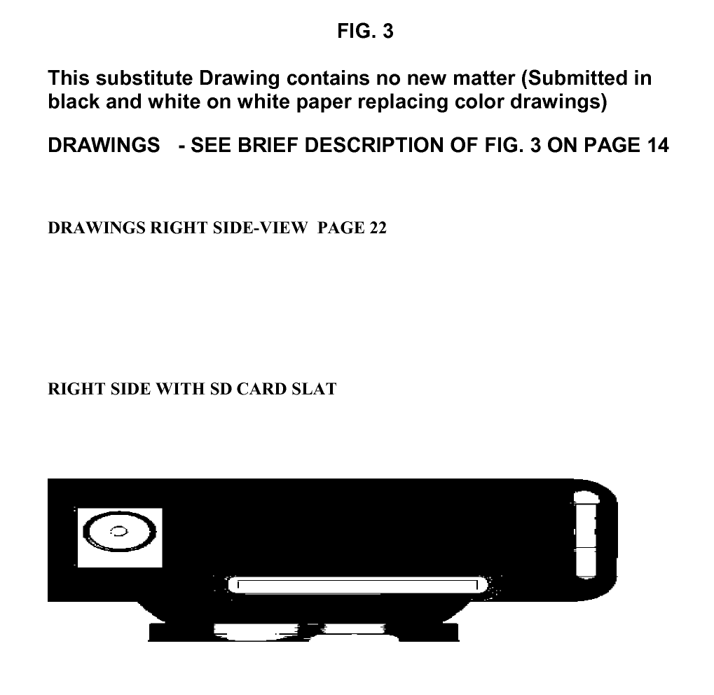

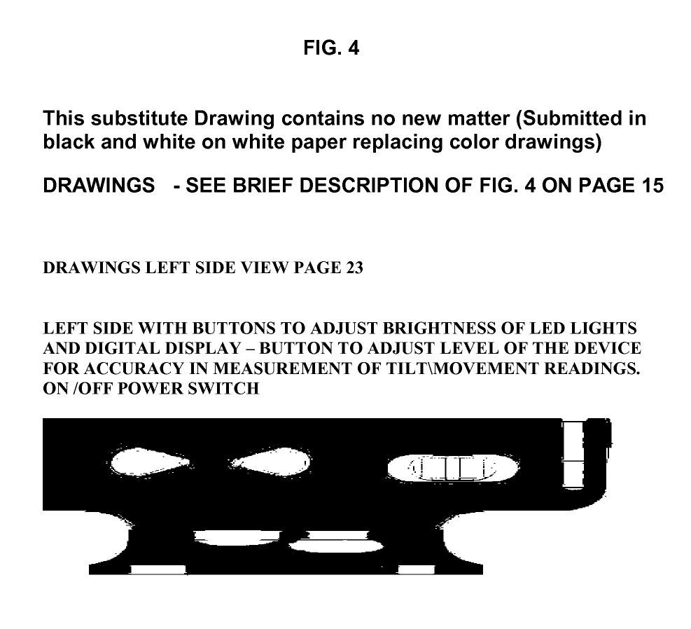

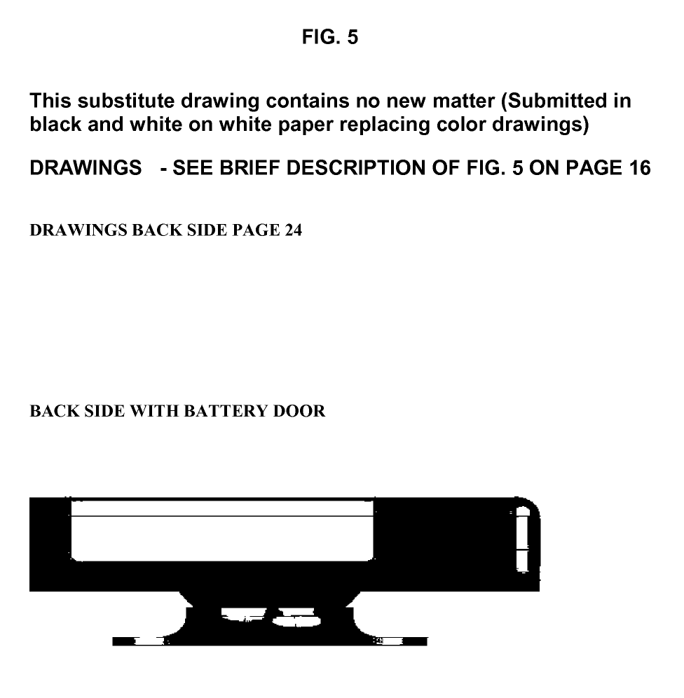

The 2-3-axis acceleration sensor/chip is used to sense XY force. The LED lights are used to show on the device Acceleration, Braking, Left and Right Turns and Swerving of the vehicle. These Led lights will be controlled by the software program listed in the Software Specification that will establish parameters for excessive acceleration, Hard Braking, Hard left/Right turns and Swerving. Three AA batteries are used to power the device along with a Power jack for 12 VDC or AC input as an alternate power supply. There will be a buzzer or sound tone alarm to alert the driver when the excessive parameter was breached. Push buttons for brightness adjustment: of the LED lights for 25%, 50%, 75%, and 100%. Day or Night driving also to set the date and time to monitor driving events visually and audibly.

These events will be recorded on the SD/flash memory that will be accessible through a PC program shown in Software Specifications. An ON/OFF switch is used to control the power to the device.

The device will have a real timer for time stamp recording and calendar to the SD Flash memory docking station for flash memory. There is also a visual display on the device that will show in digital format the Acceleration/Deceleration, Left/Right turns or excessive Swerving of the vehicle.

Two/one 5-segment LED lights display is used to show the following: 5 segment LED lights on the right display G scale. 5 levels for the vehicle Acceleration, Right turns and Swerving to the Right these are displayed as: Green LED—performance GOOD. Yellow LED—FAIR, first level warning. RED LED POOR—second level warning and buzzer will start to chirp.

5 segment LED lights on the left display in G scale 5 levels for the vehicle Braking/Deceleration, Left turns and Swerving to the Left. Green LED—performance GOOD., Yellow LED—FAIR first level warning, RED LED POOR—second level warning and buzzer will start to chirp

The center LED GREEN light represents Good driving habits.

Calendar and time recording of all events. UEI Proprietary PC software application for reading the SD flash card reading and display on the PC computer.

Enclosure adjustment: rotating 360 deg, tilting base +30 deg

Enclosure dimension: H=1.0 inch (without base) H=1.4 inch (with base) W=4 0 inch. D=2.7 inch

Software Specification:

The embedded software and SD/flash memory will show Acceleration, Deceleration, Braking and Right/Left Turns and Swerving that exceed the parameters set in the software. These will be displayed on the LED lights and visually displayed in digital format on the device. All events that exceed the driving parameters will be recorded on the SD/Flash memory that the UEI proprietary software will read from a PC Computer and display visually the event and time of the event that exceeded the driving parameters. The PC software will also show the events in bar graph form and also in a road format that will show the type of vehicle example, Truck—16 wheels, 10 wheels, 6 wheels, SUV, Car—sedan 4 doors, 2 doors, Sports car. Train, Plane. There are 11 segment display LED LIGHTS.

There are 5 levels on the right side-front of the device showing the vehicle

Acceleration, Right turns and Swerving to the Right these are displayed as: Green LED—performance GOOD. Yellow LED—FAIR, first level warning. RED LED POOR—second level warning and buzzer will start to chirp. Yellow and Red LED lights will be recorded date/time stamped on the SD/Flash memory card. There are 5 levels on the left side—front of the device showing the vehicle Braking/Deceleration, Left turns and Swerving to the Left. Green LED—performance GOOD, Yellow LED—FAIR first level warning, RED LED POOR—second level warning and buzzer will start to chirp Yellow and Red LED lights will be recorded date/time stamped on the SD/Flash memory card.

The center LED GREEN light represents Good driving habits.

The brightness button allows for adjusting the front LED brightness in few steps.

The SD flash card will store and date/time stamp all events when the Yellow or Red LED indicates that Driving exceeded the parameters. Three buttons will adjust the real time clock. The PC software allows reading and saving to the PC all recorded events.

This device with the current title of UEI FUEL & DRIVING MONITOR was first filed under a Provisional application with the title of Ulsi Fuelsaver driver Monitor (see information listed in the Supplemental application data sheet and background information for the UEI FUEL & DRIVING MONITOR.

### CROSS REFERENCE TO RELATED APPLICATION

As disclosed in the Supplemental Application Data Sheet and Background information section this invention was submitted on Jan. 7, 2008 as a Provisional Application e filed with an EFS ID #3131810 Application No. 61/019,496 Confirmation #2920 Inventor Paul Benyola and a change in the Firm name from Universal Light & Sound Innovations LTD to Universal Energy Innovations, LLC. The Title of the invention was Ulsi fuelsaver driver monitor the current Title is UEI Fuel & Driving monitor.

### BACKGROUND OF THE INVENTION

This invention was developed due to the problem of the high cost of oil, which then increased the cost of fuel to record cost per gallon exceeding $4.00. This invention UEI FUEL & DRIVING MONITOR is using Tilt switch and/or an accelerometer to determine the movement/events of: acceleration, braking, left turn, right turn and swerving of the vehicle that exceeds the parameters programmed into the software. The parameters that are exceeded will be transferred as information that is captured to led lights to show fuel consumption and driving habits as Green is good, Yellow is fair, Red is poor. In addition to the LED lights there will be a digital counter that will act as a calendar/Time clock and also as a digital numerical display showing the events. The events will be time stamped with the Date and Time set up in the device within the unit and placed on a Secure Digital memory card that will capture the driving events. This SD card will then be placed into a PC computer program that will show the events along with a time stamp. This will allow the driver to modify their driving habits, which will increase mileage to save fuel/wear on the brakes, engine and also monitor driving habits that will make them safer drivers.

### BRIEF SUMMARY OF THE INVENTION

Tilt switch and/or Accelerometer with electronic components will capture the driving data to light up led lights which equates to a series of led lights that light which will display a series of messages such as GREEN=GOOD, YELLOW=FAIR, RED=POOR

In addition to the LED lights there will be a digital counter that will act as a calendar/Time clock and also as a digital numerical display showing the events. The events will be time stamped with the Date and Time set up in the device within the unit and placed on a Secure Digital memory card that will capture the driving events. This SD card will then be placed into a PC computer program that will show the events along with a time stamp.

This will allow a driver to modify their driving habits to exhibit the best display. According to published and test data good driving habits makes the driver safer, reduces wear on the automobile, brakes, tires and engine. The mileage should increase in all vehicles Auto or Trucks by an average of 3% to 10%, which equates to 1 or 2 gallons of fuel per tank. This helps solve an urgent problem to conserve gasoline and fuel.

### BRIEF DESCRIPTION OF SEVERAL VIEWS OF THE DRAWING

Drawing Page 17 UEI FUEL& DRIVING MONITOR

Vehicle/Power Source 1,2 & 3

Variable using LED L1 thru G10 5 led lights.

LR1 thru LR6—Components of the UEI FUEL & DRIVING MONITOR

L1 thru L2—LED RED=POOR Fuel/Driving monitor lights: Braking/Left turn/Swerving

R1 thru R2—LED RED=POOR Fuel/Driving monitor lights: Acceleration/Right turn/Swerving/

L3 thru L4—LED YELLOW=FAIR Fuel/Driving monitor lights: Braking/Left turn/Swerving

R3 thru R4—LED YELLOW=FAIR Fuel/Driving monitor lights: Acceleration/Right Turn/Swerving

L5 LED GREEN=GOOD Fuel/Driving monitor lights: Braking/Left turn Swerving

R5 LED GREEN=GOOD Fuel/Driving monitor lights: Acceleration/Right Turn/Swerving

G10 LED GREEN/BLUE=Good driving

Left side of front view is a clock for time stamping driving events and also will be used as a digital display to track and record driving events that exceed the established parameters. Example fast acceleration, hard braking, sharp left or right turns and swerving. These events will be recorded on a SD/and retrieved by a PC program for analysis of driving habits. The LED lights will give the driver immediate visual and audio output of their driving and fuel consumption by displaying RED=POOR, YELLOW=FAIR, GREEN=GOOD, by modifying their driving habits To drive mostly in the GREEN=GOOD area they will achieve better fuel economy and will be a safer driver.

Drawing UEI FUEL& DRIVING MONITOR

LEFT Side View PAGE 19 of the invention UEI FUEL & DRIVING MONITOR

Power Jack and SD card Slat

Drawing UEI FUEL& DRIVING MONITOR

RIGHT Side View PAGE 20 of the invention UEI FUEL & DRIVING MONITOR

Buttons to control the brightness of the LED's and also to set the clock Power switch ON/OFF

Drawing UEI FUEL& DRIVING MONITOR

BACK Side View PAGE 21 of the invention UEI FUEL & DRIVING MONITOR Battery Door

### DETAILED DESCRIPTION OF THE INVENTION

Uses a Tilt switch and/or an accelerometer to determine the movement/events of: acceleration, braking, left turn, right turn and swerving of the vehicle that exceeds the parameters programmed into Universal Energy Innovations' LLC proprietary software and hardware device. The software has unique preprogrammed parameters that will show excessive acceleration or deceleration (braking) hard left or right turns and swerving) The parameters that are exceeded will be transferred as information that is captured to led lights to show fuel consumption and driving habits as Green is good, Yellow is fair, Red is poor. In addition to the LED lights there will be an audio tone that will alert the driver when they exceed the parameters. In addition the digital counter that will act as a calendar/Time clock and also as a digital numerical display showing the events. The events that exceed the parameters will be time stamped with the Date and Time set up in the device within the unit and placed on a Secure Digital memory card that will capture the driving events. This SD card will then be placed into a PC computer program proprietary to Universal Energy Innovations LLC that will show the events along with a time stamp. This will allow the driver to modify their driving habits, which will increase mileage to save fuel/wear on the brakes, engine and also monitor driving habits that will make them safer drivers.

1. The UEI FUEL & DRIVING MONITOR with the proprietary software and hardware will allow the driver to modify their driving habits, which will increase mileage to save fuel/wear on the brakes, engine and also allow them to become safer drivers.
1. The events will be recorded and retrieved by a PC program for analysis of driving habits. The LED lights will give the driver immediate visual and audio output of their driving and fuel consumption by displaying RED=POOR, YELLOW=FAIR, GREEN=GOOD, by modifying their driving habits to drive mostly in the GREEN =GOOD area they will:
2. Achieve better fuel economy. Independent test have shown that if you take your time and slow down you can increase your mileage by driving smoothly avoid jackrabbit starts, over braking, sharp left or right turns and swerving. Conservative driving may increase miles per gallon in all vehicles Auto or Trucks by an average of 3% to 10%, which equates to 1 or 2 gallons of fuel per tank fill up.
3. Become a safer driver Independent test have shown that by modifying your driving habits, reduce jackrabbit starts, excessive braking and swerving, will help keep your vehicle under control.
4. Reduce wear on the automobile, brakes, tires, and engine.
